(19) United States
(12) Patent Application Publication
(10) Pub. No.: US 2005/0212944 A1
(43) Pub. Date: Sep. 29, 2005

(54) Digital photograph storage and viewing device

(76) Inventor: Gideon Guy, Chatsworth, CA (US)

Correspondence Address: SoCAL IP LAW GROUP LLP, 310 N. WESTLAKE BLVD. STE 120, WESTLAKE VILLAGE, CA, 91362, US

(21) Appl. No.: 10/807,753

(22) Filed: Mar. 23, 2004

(51) Int. Cl. H04N 5/222

(52) U.S. Cl. 348/333.07

(57) ABSTRACT

There is disclosed a dedicated digital photograph storage and viewing device. The dedicated digital photograph storage and viewing device may include a high resolution display, a removably attached integrated digital camera, a storage medium to store photographs, a permanently attached storage device to access the storage medium, a plurality of user input devices to control viewing of digital photographs on the display as a digital photograph album. Software may be included to allow for viewing the photographs.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

This application is related to digital photography and photograph albums.

2. Description of Related Art

Traditionally, people took photographs with a camera, had their film processed, and stored the resulting photographs in albums. Photograph albums may easily be stored on bookshelves, on coffee tables and other locations readily accessible for quick and easy viewing.

With the ever diminishing sizes of electronics, the quality and popularity of digital cameras has increased dramatically. Digital photographs are often transferred from the digital camera or digital media card from the camera to a personal computer for editing and viewing. Digital photographs are often printed at home and may be printed at photography stores, pharmacies and other locales that also process film into prints. The photographs printed from digital photographs are then placed in traditional albums for traditional viewing.

Digital photographs may be stored on a compact disc (CD) or digital versatile disc (DVD) and played on a DVD player for viewing on a television display. Using software applications on a personal computer, digital photographs may be arranged as a slide show for viewing on a personal computer and for storage on a CD or DVD for playing on a DVD player and viewing on a television display.

Digital photographs may also be viewed directly on a small display screen incorporated in a digital camera. Many digital cameras may be attached to a television display for viewing digital photographs.

### DESCRIPTION OF THE DRAWINGS

FIG. 1 is a block diagram of a digital photograph storage and viewing device having a removably attachable digital camera according to the invention described herein.

FIG. 2 is a schematic diagram of the hardware devices included in a digital photograph storage and viewing device having a removably attachable digital camera according to the invention described herein.

FIG. 3 is a block diagram of the software included in a digital photograph storage and viewing device having a removably attachable digital camera according to the invention described herein.

### DETAILED DESCRIPTION OF THE INVENTION

Throughout this description, the embodiments and examples shown should be considered as exemplars, rather than limitations on the apparatus and methods of the present invention.

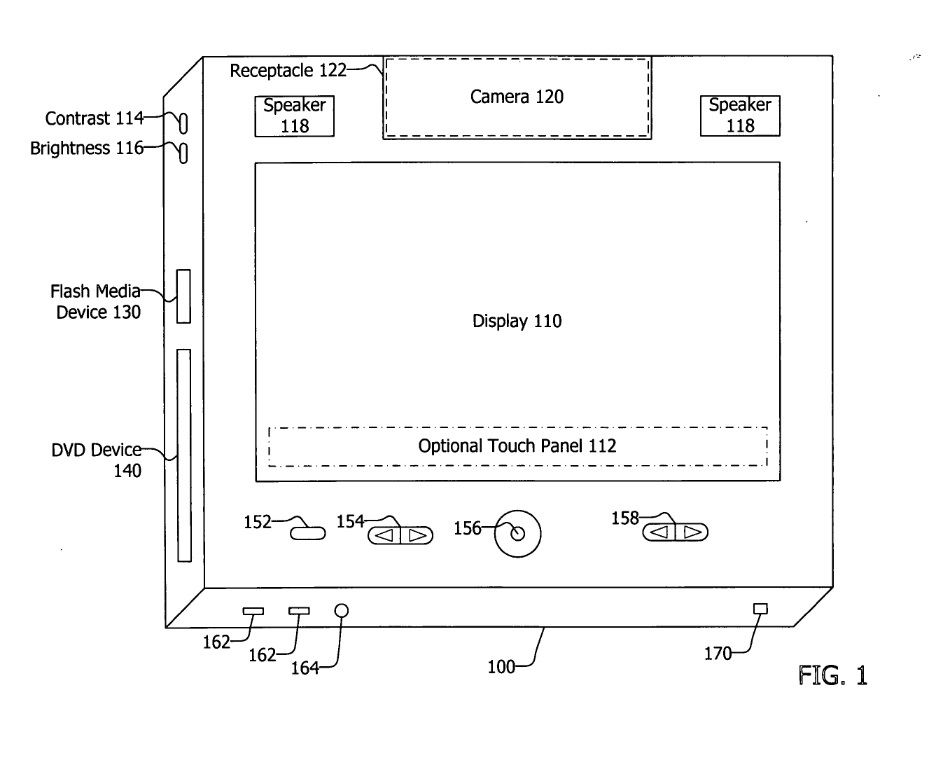

FIG. 1 is a block diagram of a digital photograph storage and viewing device 100 having an integrated removably attachable digital camera 120. The digital photograph storage and viewing device 100 is referred to herein as a PVD—photograph viewing device. The PVD 100 includes a high resolution display 110, an integrated removably attached digital camera 120, and user interface devices such as buttons, knobs, scroll wheels, and others, to allow for navigating the software on the PVD 100 and for scrolling through and otherwise accessing the photographs stored on PVD 100.

The digital photographs stored in and accessible by the PVD 100 and which may be captured by the removably attached digital camera 120 may include a photograph and associated metadata. The metadata may include the time and date the photograph was taken, the ISO or ASA of the camera at the time the photograph was taken, the f-stop or aperture setting of the photograph, the shutter speed of the photograph, whether a flash was used, and others. The digital photographs and associated metadata stored in and accessible by the PVD 100 and which may be captured by the removably attached digital camera 120 may be stored in the Joint Photographic Experts Group (JPEG), Graphics Interchange Format (GIF), Tagged Image File Format (TIFF), Exchangeable Image File (EXIF), and/or other format.

The PVD 100 includes a high resolution display 110 having dimensions no smaller than four by six inches and no larger than that which can be easily held by a person. The display 110 may be rectangular. The display 110 may be bigger, such as five by seven inches, five by eight inches, six by nine inches, and others. The PVD 100 is no larger than the largest traditional photo albums in length and width. The high resolution display 110 may also be square, such as, for example, six inches or eight inches square. The high resolution display may also be round or oval. The depth of the PVD 100 is generally thin, and is typically from 0.75″ to 1.25″ thick, and may be thicker and thinner.

The high resolution display 110 has a resolution of at least a 128 pixels per inch (ppi) or dots per inch (dpi), and may be greater, such as 160, 200, 256, 300 dpi, and others.

The display 110 may be manufactured from any technology that will yield sufficiently good photograph viewing in a home, business or other setting. The display 110 may be a liquid crystal display (LCD), a thin film transistor (TFT) display, an active matrix display, a plasma display, an electroluminescent display (ELD), a field emission display, or other thin, flat panel technology that has low power consumption. The power consumption may be less than 5 watts, and may consume both more and less energy.

In one embodiment, the display 110 has an optional touch panel portion 112. Various user interface controls may be provided via the optional touch panel 112. The touch panel 112 may be included in place of or in addition to the various other user interface devices described herein.

Various user interface devices may be included on the PVD 100. Knobs, dials, sliders or other user interface devices may be provided to adjust the contrast, brightness and other features of the display 110, such as, for example, contrast knob 114 and brightness knob 116. Paired push buttons 154 may be included to allow a user to zoom in and zoom out when viewing a photograph. Paired push buttons 158 may be included to allow a user to scroll forward and scroll back between photographs in a group of photographs being viewed. One ore more single buttons 152 may be included to provide various features such as, for example, to bring up a help screen or bring a user to a start page. A scroll wheel and select or pointer combination 156 may be provided to allow a user to navigate through the various features provided by the PVD 100. In some embodiments the contrast, brightness, zoom, scroll and other features of the PVD 100 may be controlled via a software user interface accessible via the optional touch panel 112, via the scroll wheel/select combination 156, and/or via user interface devices other than those depicted and described.

The PVD 100 may include one or more communications interfaces, such as, for example, universal serial bus (USB) ports 162 and infra red device 164. The communications interfaces may allow the PVD 100 to communicate with other devices to send and received digital photographs. Other information, computer programs, and other files may be communicated via the communications interfaces. The communications interfaces may be an interface, port, connector or device that allows for the transmission of and/or receipt of information, including, but not limited to, USB, IEEE 1394 (also known as Firewire® and i.link®), infrared, WiFi (also known as IEEE 802.11), Bluetooth, and others.

The PVD 100 includes an integrated digital camera 120 which is removably attached to the PVD 100. The digital camera 120 may sit in a digital camera receptacle 122 in the PVD 100. The digital camera receptacle 122 and the digital camera 120 may have corresponding interfaces for the transfer of digital photographs from the digital camera 120 to the PVD 100. The corresponding interfaces for the transfer of digital photographs may be via a communications interface that provides for the transfer of digital photographs via USB, IEEE 1394, infrared, WiFi, Bluetooth, and other protocols and techniques. The digital photographs captured by and stored on the digital camera 120 may be automatically transferred to the PVD 100 when the digital camera 120 is placed in the receptacle 122.

The corresponding interfaces may be physical, such as male and female or friction, and may be wireless. The digital camera receptacle 122 and the digital camera 120 may have corresponding electrical power connections (for example, male and female) by which the digital camera may receive electrical power from the PVD 100 to charge a rechargeable battery attached to or included in the digital camera 122.

The removably attachable digital camera 120 may be a 2, 3, 4, 5, 6 or other megapixel digital camera that may be fixed focus, may include a digital zoom, may include an optical zoom, and may include various other features. The removably attachable digital camera 120 may include a flash memory card in a flash memory receptacle in the removably attachable digital camera 120.

Electrical power may be provided to the PVD 100 by a battery and/or via an electrical connector that may be plugged into electrical receptacle 170 included in the PVD 100. The PVD 100 may include a place for externally and/or internally mounting a battery or battery pack.

The photographs that may be viewed with PVD 100 may be augmented with audio that may be reproduced on speakers 118. A built in microphone (not shown) or a microphone input receptacle (not shown) may be provided with the PVD 100 to capture audio. Audio may be paired with a digital photograph or a group of digital photographs arranged as an album. Audio may be stored in formats such as wavetable (WAV), Audio Interchange File Format (AIFF), Moving Picture Expert Group layer 3 (MP3), Musical Instrument Digital Interface (MIDI), and others.

The PVD 100 may include an internal storage to store multiple digital photographs. The internal storage may be permanently attached or may be removable. The internal storage may include at least one machine readable medium and at least one storage device. A machine readable medium includes, for example, magnetic media such as hard disks, microdrives, minidrives, floppy disks and tape; optical media such as compact disks (CD-ROM and CD-RW) and digital versatile disks (DVD and DVD±RW); flash memory cards (CompactFlash, secure digital (SD) memory card, and xD Picture Card, for example); and others. As used herein, a storage device is a device that allows for reading from and/or writing to a machine readable medium. Storage devices include, hard disk drives, microdrives, CD drives, DVD drives, flash memory card readers and/or writers, and others. As shown, the PVD 100 includes a DVD device 140 and a flash media device 130. In one embodiment, the PVD 100 includes an internal DVD device 140 and no other machine readable media or storage device. The digital photographs may be managed and arranged on the internal storage by a user interface provided by software that allows for managing the digital photographs on the internal storage.

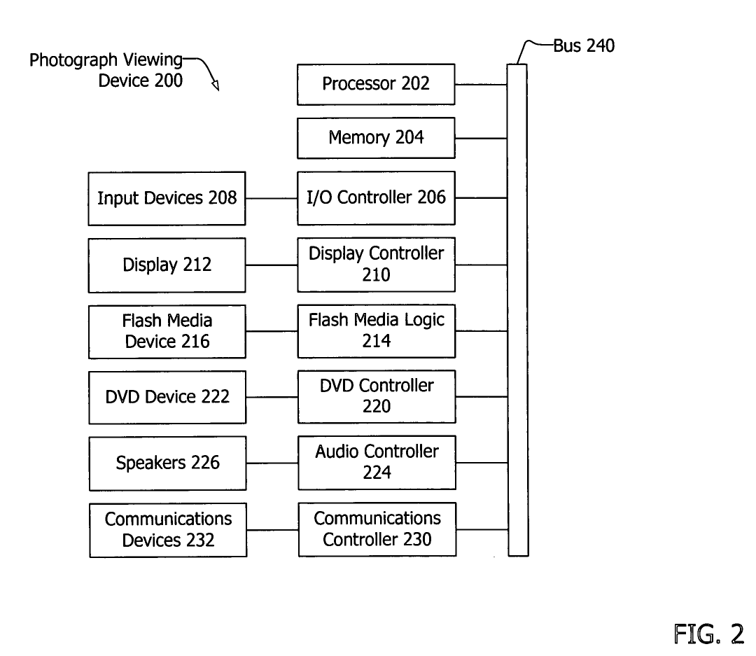

FIG. 2 is a schematic diagram of the hardware devices included in a digital photograph storage and viewing device 200 having a removably attachable digital camera. The PVD 200 may include a processor 202, such as a microprocessor, and memory 204, such as random access memory, coupled to a bus 240. Although depicted as a single bus, bus 240 may be one or more each of a data bus and a command bus. Processor 202 may execute software to achieve the functionality of the PVD 200.

An input/output (I/O) controller 206 may be included to receive and process input from user input devices 208, such as for example, devices 114, 116, 152, 154, 156 and 158 discussed above with regard to FIG. 1. A display controller 210 may be included to control the functioning of a display 212 included in the PVD 200. Flash media logic 214 may be included to allow for the reading from and/or writing to flash media devices 216. A DVD controller 220 may be included to allow for the reading from and/or writing to DVD device 222. An audio controller 224 may be included to allow for the capture and/or play back of audio via speakers 226 and a microphone (not shown). A communications controller 230 may be provided to allow for communications to and from communications devices 232.

The I/O controller 206, the display controller 210, the flash media logic 214, the DVD controller 220, the audio controller 224, and the communications controller 230 may be coupled to bus 240. In addition, some of the I/O controller 206, the display controller 210, the flash media logic 214, the DVD controller 220, the audio controller 224, and the communications controller 230 may be directly coupled to one another.

Each of the I/O controller 206, the display controller 210, the flash media logic 214, the DVD controller 220, the audio controller 224, and the communications controller 230 may be hardware, software, firmware, or a combination thereof. Some of the I/O controller 206, the display controller 210, the flash media logic 214, the DVD controller 220, the audio controller 224, and the communications controller 230 may be combined with one another, may be included with the processor 202, and may be included on an FPGA.

Additional and fewer units, modules or other arrangement of software, hardware and data structures may be used to achieve the device described herein.

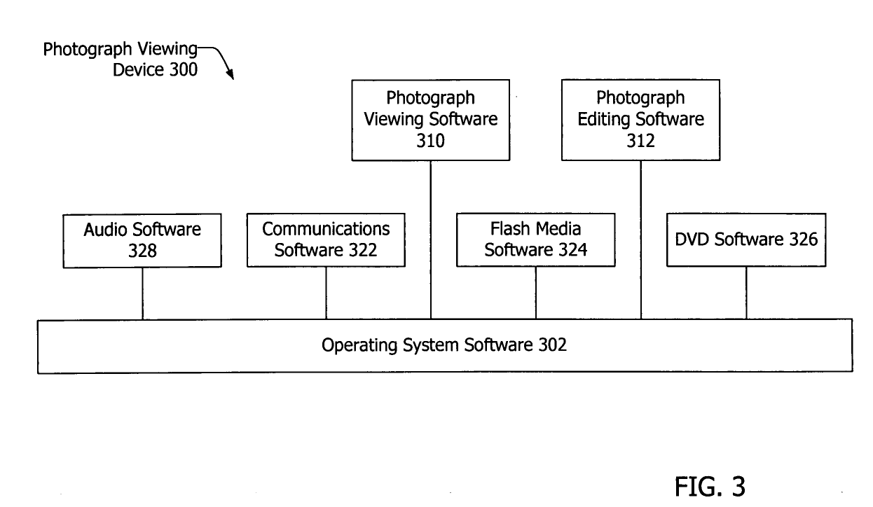

FIG. 3 is a block diagram of the software included in a digital photograph storage and viewing device 300 having a removably attachable digital camera. The various software components may be stored for execution by a processor in the PVD 300 on one or more of an internal flash memory, on an electronically erasable programmable read-only memory (EEPROM) device, an FPGA on an internal hard disk drive or microdrive, or on another storage medium.

The PVD 300 may include an operating system 302 through which the other software components communicate with and through the hardware components described above in FIG. 2. The operating system 302 may be a real-time operating system, and may be proprietary. The operating system 302 may be a version of LINUX, Microsoft Windows CE or other operating system.

At the heart of the PVD 300 is photograph viewing software (PVS) 310. PVS 310 allows a user to create and view photograph albums from photographs transferred from a removably attached digital camera, transferred from another digital camera attached via a communications interface, retrieved from a storage medium such as a flash memory device, or retrieved from a storage medium or memory internal to the removably attached digital camera. The PVS 310 may allow for the creation of albums automatically and/or by the user. Photographs may be arranged by the PVS 310 automatically or as directed by a user, such as by date, by subject, by predominant color, by any of various associated metadata, and others. The user may also arrange the photographs into albums at will. The PVS 310 provides a user the ability to designate groupings of photographs as albums. In this way, the PVS allows a user to manage the photographs and the internal storage included in PVD 100. The PVS 310 may allow users to add captions and text descriptions to photographs and albums. The PVS 310 provides a user the ability to flip through photographs and to flip between albums. In this way, the PVS 310 allows the PVD 300 to behave as a traditional photograph album.

The PVS 310 may also allow the user to zoom into various portions of photographs to various degrees. This may be achieved with a zoom button and/or with a scroll wheel and selector combination, and or via a touch screen interface, as described above with regard to FIG. 1.

The PVS 310 may also allow a user some rudimentary editing and other control of digital photographs. The PVS 310 may allow a user to designate whether the photograph should be viewed in landscape or portrait. The PVS 310 may allow a user to adjust color, contrast, balance and other limited characteristics of the photographs.

In some embodiments, photograph editing software (PES) 312 is included in the PVD 300. The PES 312 may provide a user of a PVD to edit various characteristics of digital photographs, and may provide features such as cropping, red-eye removal, color adjustment, brightness adjustment, and contrast adjustment. The PES 312 may allow a user to enhance, augment and add features to photographs and albums. These enhancements and features may include cropping, box and border effects, posterize, resolution adjustment, change number of colors, and others. The PES 312 and PVS 310 may be combined as a single program or software entity.

Audio software 328 may provide support for the capturing and/or playback of audio to accompany photographs and/or groupings of photographs viewed as an album.

Communications software 322 may provide support for various communications protocols such as USB, IEEE 1394, infrared, WiFi, BlueTooth, and others.

Flash media software 324 may provide support for the reading and writing of files from flash media such as SD memory, CompactFlash, and others.

DVD software 326 may allow a user to read to and write from a DVD medium, and may allow the user to create slideshows of digital photographs which may be sorted on and executed from a DVD player for viewing on a television or similar display.

Additional and fewer units, modules or other arrangement of software may be used to achieve the PVD described herein.

In other embodiments the PVDs described herein may be augmented with software, hardware and/or firmware to allow the playback, editing, and/or creation of video in one or more formats such as, for example, MPEG, Quicktime®, Audio Video Interleave (AVI), Windows Media®, and others. In one embodiment, the removably attached digital camera may be replaced with a removably attached digital video camera that allows for the capturing of videos and still images.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications and alterations should therefore be seen as within the scope of the present invention.

1. A digital photograph storage and viewing device comprising:
a high resolution display
a removably attached integrated digital camera
a storage medium to store photographs
a permanently attached storage device to access the storage medium
photograph viewing software to allow a user to arrange digital photographs into at least one digital photograph album
a plurality of user input devices to control viewing of digital photographs on the display as the digital photograph album.

2. The digital photograph storage and viewing device of claim 1 wherein the display has a resolution of at least 128 dots per inch.

3. The digital photograph storage and viewing device of claim 1 wherein the display has a resolution of at least 200 dots per inch.

4. The digital photograph storage and viewing device of claim 1 wherein the display has a resolution of at least 300 dots per inch.

5. The digital photograph storage and viewing device of claim 1 wherein the display has a height of at least five inches and a width of at least eight inches.

6. The digital photograph storage and viewing device of claim 1 wherein the display includes a touch screen portion to receive user input.

7. The digital photograph storage and viewing device of claim 1 wherein the storage medium is a digital versatile disc (DVD), and the storage device is a DVD device.

8. The digital photograph storage and viewing device of claim 1 further comprising software to allow for editing of the digital photographs.

9. The digital photograph storage and viewing device of claim 1 further comprising software that provides a user interface by which a user may view the digital photographs as a photo album.

10. The digital photograph storage and viewing device of claim 1 further comprising software that provides a user interface by which a user may view the digital photographs as a slide show.

11. The digital photograph storage and viewing device of claim 1 further comprising a communications interface by which the digital photographs are transferred from the integrated digital camera to the storage medium.

12. The digital photograph storage and viewing device of claim 11 wherein the communications interface supports at least one of a Universal Serial Bus (USB) interface, an IEEE 1394 interface, a BlueTooth interface, an infrared interface, and an IEEE 802.11 interface.

13. A digital photograph storage and viewing device comprising:
a plurality of user input devices including a first user input device to allow for scrolling through a plurality of digital photographs and a second user input device to allow for zooming in and out when viewing the digital photographs
a high resolution display controllable by at least a third user input device of the user input devices
a storage medium to store the digital photographs
a processor
a memory
a digital camera integrated with and removably attached to the digital photograph storage and viewing device, the digital camera to capture the digital photographs and store the digital photographs on the storage medium
wherein the processor and the memory comprise circuits and software for managing storage of and displaying digital photographs.

14. The digital photograph storage and viewing device of claim 13 wherein the high resolution display has a resolution of at least 128 dots per inch.

15. The digital photograph storage and viewing device of claim 13 wherein the high resolution display has a resolution of at least 200 dots per inch.

16. The digital photograph storage and viewing device of claim 13 wherein the high resolution display has a resolution of at least 300 dots per inch.

17. The digital photograph storage and viewing device of claim 13 wherein the high resolution display has a height of at least five inches and a width of at least eight inches.

18. The digital photograph storage and viewing device of claim 13 wherein the high resolution display includes a touch screen portion to receive user input.

19. The digital photograph storage and viewing device of claim 13 wherein the storage medium is a digital versatile disc (DVD), and the storage device is a DVD device.

20. The digital photograph storage and viewing device of claim 13 further comprising software to allow for editing of the digital photographs.

21. The digital photograph storage and viewing device of claim 13 further comprising software that provides a user interface by which a user may view the digital photographs as a photo album.

22. The digital photograph storage and viewing device of claim 13 further comprising software that provides a user interface by which a user may view the digital photographs as a slide show.

23. The digital photograph storage and viewing device of claim 13 further comprising a communications interface by which the digital photographs are transferred from the integrated digital camera to the storage medium.

24. The digital photograph storage and viewing device of claim 23 wherein the communications interface supports at least one of a Universal Serial Bus (USB) interface, an IEEE 1394 interface, a BlueTooth interface, an infrared interface, and an IEEE 802.11 interface.
